(19) United States
(12) Patent Application Publication
(10) Pub. No.: US 2009/0146976 A1
(43) Pub. Date: Jun. 11, 2009

(54) Method of interrupting computer usage

(76) Inventor: Kuochuan HSIEH, Taoyuan City (TW)

Correspondence Address: LEONG C LEI, PMB # 1008, 1867 YGNACIO VALLEY ROAD, WALNUT CREEK, CA, 94598, US

(21) Appl. No.: 11/953,885

(22) Filed: Dec. 11, 2007

(51) Int. Cl. G09G 5/00

(52) U.S. Cl. 345/204; 340/825.22

(57) ABSTRACT

The novel method is embodied in a control circuit of a display device and a remote controller configuring the operation of the control circuit. The control circuit is positioned along the paths of video signals and electrical voltages to a display circuit driving the display device. By interrupting the electrical voltages or the video signals to the display circuit, the display device would not be able to function and therefore a user is prohibited from using the computer. The remote controller provides a convenient means for configuring the control circuit such as changing a password and setting a period of time within which the video signals or the electrical voltages are allowed to be passed to the display circuit.

### TECHNICAL FIELD OF THE INVENTION

The present invention generally relates to devices for interrupting computer usage, and more particularly to such a device that interrupts the delivery of video signals from the computer to a display device.

### DESCRIPTION OF THE PRIOR ART

Most of today's parents are troubled by the obsession of their children in online games or web surfing. Strict forbiddance of the children's use of computer or network is not reasonable as using network to search information and using computer to prepare homework are major parts of the children's study activity. Therefore, how to establish a controlled access to the network and the computer that are reasonable to both the parents and the children is an issue that every modern family has to deal with.

### SUMMARY OF THE INVENTION

Accordingly, a novel method is provided herein which is embodied in a control circuit of a display device connected to a computer and a remote controller configuring the operation of the control circuit.

The control circuit is positioned between a display circuit driving the screen of the display device and the video signals and electrical voltages driving the display circuit. By interrupting the electrical voltages or the video signals to the display circuit, the display device would be able to function and therefore a user is prohibited from using the computer.

The remote controller provides a convenient means for configuring the control circuit such as changing a password and setting a period of time within which the video signals or the electrical voltages are allowed to be passed to the display circuit.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the function blocks of the control circuit embodying the method of the present invention.

FIG. 2 is a schematic diagram showing another embodiment of the control circuit of the present invention.

FIG. 3 is a detailed layout diagram showing the control circuit of FIG. 2.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

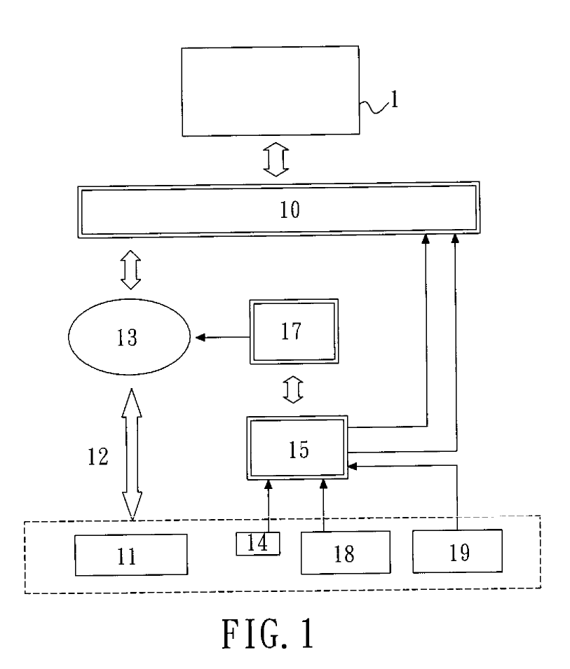

The method provided by the present invention is embodied in a control circuit and a remote controller. A schematic diagram of the functional blocks of the control circuit is shown in FIG. 1. As illustrated, a screen 1 of a display device is driven signally and electrically by a display circuit 10 of the display device. On the other hand, the display device has a video connector 11, such as a VGA connector, for receiving video signals from, say, a computer. The display device also has power-in connector 19 for receiving direct-current (DC) voltages and an on-screen display (OSD) control board 18 for adjusting the image quality displayed on the screen 1. The control circuit is positioned on the paths of the video signals (from the video connector 11), OSD control signals (from the OSD control board 18), and the DC voltages (from the power-in connector 19) to the display circuit 10.

The control circuit contains a remote OSD controller 15 which, on one hand, receives the DC voltages, such as 12V, 5V, and ground (shown as GN) from the power-in connector 19 and in turn forwards them to the display circuit 10. Therefore, by interrupting the provision of the DC voltages to the display circuit 10, the remote OSD controller 15 is able to turn off the display of the screen 1.

On the other hand, the remote OSD controller 15 also receives the OSD control signal from the OSD control board 18 and forwards them to the OSD controller 17 via a bus, such as the I2C bus. The OSD controller 17, based on the OSD control signal, generates appropriate OSD images that are mixed with the video signals 12 from the video connector 11 by a signal mixer 13. The mixed video signals are then provided to the display circuit 10 so that the OSD images are overlaid on the images of the video signals 12.

The control circuit further contains an infrared receiver 14 capable of receiving infrared signals, say, conforming to the IrDA (Infrared Data Association) standard. As such, the remote OSD controller 15, which receives infrared signals from the Infrared receiver 14, is able to interact with the remote controller of the present invention emanating appropriate infrared signals. And the interaction process can be shown on the screen 1 of display device via the above-mentioned OSD controller 17 and the signal mixer 13.

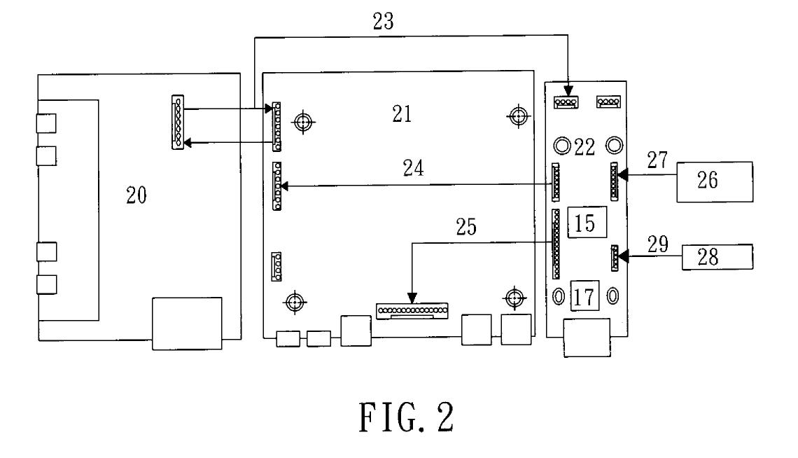

FIG. 2 is a schematic diagram showing another embodiment of the control circuit. As illustrated, the remote OSD controller 15 and the OSD controller 17 are positioned on a control circuit board 22. The circuit board 22 is connected to an OSD control board 26 (i.e., the OSD control board 18 of FIG. 1) via an OSD cable 27 and an infrared receiver 28 (i.e., the i d receiver 14 of FIG. 1) via an IR cable 29. The screen of the display device (both not shown) is driven by a display circuit board 21 (i.e., the display circuit 10 of FIG. 1) which receives the OSD control signals and the video signals from the control circuit board 22 via an OSD cable 24 and a VGA cable 25, respectively. An inverter and power supply board 20 provides the DC voltages required by the display circuit board 21 and the control circuit board 22 (via power cable 23).

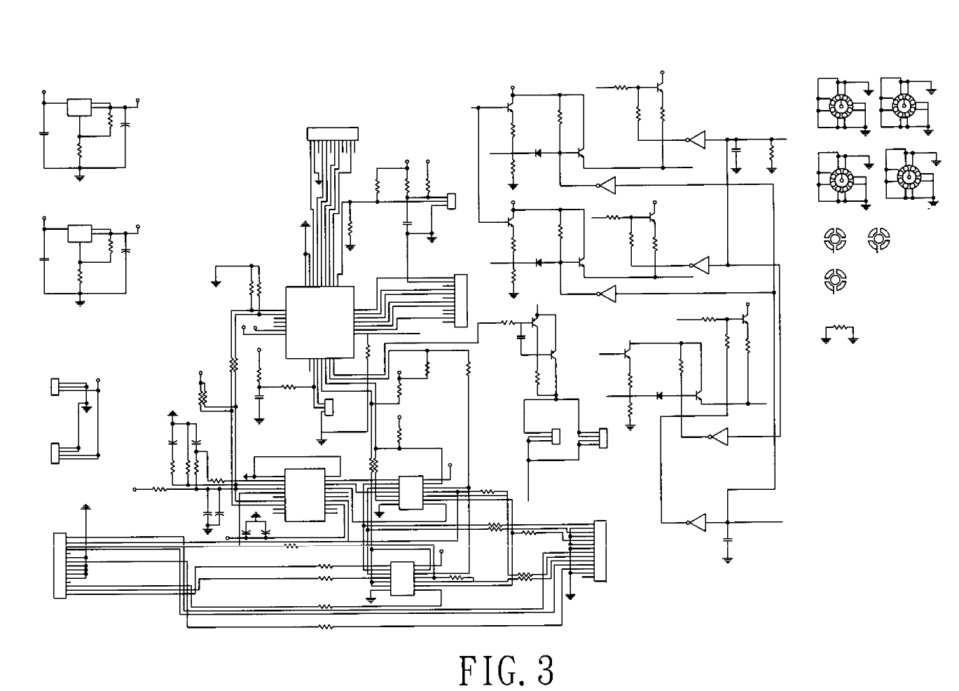

FIG. 3 is a detailed layout diagram showing the control circuit of FIG. 2, which illustrates in details the implementation feasibility of the present invention.

To use the remote controller and the control circuit of the present invention for the first time, the computer providing the video signals and the display device are all turned on. Initially, the screen of the display device will show a frame asking for a password, which is generated by the remote OSD controller 15. A user can enter the password via the keys on the remote controller. Then, the remote OSD controller can display a second frame which lists a number of functions that the user can choose (again, via the keys of the remote controller). For example, the user can change the password, set the number of retry in entering a correct password, set a period of time within which the video signals (or electrical voltages) are allowed to be passed to the display circuit.

As such, when the set period of time expires, the remote OSD controller can interrupt the deliver of DC voltages (as shown in FIG. 1) or interrupt the delivery of the video signals (as shown in FIG. 2) to the display circuit so that, without display, the computer basically cannot be used.

In an alternative embodiment, the remote controller and, therefore, the infrared receiver as well, are all omitted and their functions are integrated in the OSD control board. In another embodiment, with a touch panel, the configuration of the remote OSD controller is implemented by showing a control panel on the screen and by the user pressing the keys shown on the screen.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for interrupting computer usage, comprising the steps of:
providing a control circuit in a display device connected to a computer, said control circuit being positioned in at least one of the paths of video signals and electrical voltages to a display circuit driving a screen of said display device; and
providing a remote controller capable of configuring said control circuit via infrared from a distance.

2. The method according to claim 1, wherein said remote controller configures at least a password of said control circuit and a period of time within which said control circuit allows said video signals or said electrical voltages to be delivered to said display circuit.

3. The method according to claim 1, firer comprising the step of:
displaying on said screen an image of showing the configuration of said control circuit by said remote controller by mixing said image signal with said video signals.

4. The method according to claim 1, further comprising the step of
displaying on said screen an image guiding the configuration of said control circuit by said remote controller by mixing said image signal with said video signals.
